(19) United States
(12) Patent Application Publication
(10) Pub. No.: US 2014/0071802 A1
(43) Pub. Date: Mar. 13, 2014

(54) NODE AND METHOD FOR MANAGING A MAXIMUM TRANSFER UNIT RELATED PATH FAILURE

(71) Applicants: Oleg KLIMIN, Bor (RU); Mikhail PLOTKIN, Nizhniy Novgorod (RU)

(72) Inventors: Oleg KLIMIN, Bor (RU); Mikhail PLOTKIN, Nizhniy Novgorod (RU)

(73) Assignee: TELEFONAKTIEBOLAGET L M ERICSSON (PUBL), Stockholm (SE)

(21) Appl. No.: 13/610,916

(22) Filed: Sep. 12, 2012

(51) Int. Cl. H04L 12/24

(52) U.S. Cl. 370/216

(57) ABSTRACT

Example embodiments presented herein are directed towards the management of a Maximum Transfer Unit (MTU) related path failure. The example embodiments comprise an originating node, or a node sending a data message, identifying a path with a re-transmission count that is equal to or greater than a predetermined heartbeat threshold value. The originating node further extends a heartbeat message size according to a maximum message transfer size. The originating sends the extended heartbeat message of the identified path and manages the identified path based on results of the extended heartbeat message transmission.

### BACKGROUND

A path maximum transmission unit size (MTU) of a communications protocol layer is the maximum frame size in bytes of the largest protocol data unit that the layer can forward. MTU size parameters are associated with a network interface card.

A larger size of MTU creates better efficiency because each packet carries more user data while protocol overheads, such as headers or underlying per-packet delays, remain fixed; the resulting higher efficiency means a slight improvement in bulk protocol throughput. A larger MTU size also means processing of fewer packets for the same amount of data. In some systems, per-packet-processing can be a critical performance limitation.

MTU size can vary in different network segments due to multiple encapsulation protocols, such as MPLS, IPSec etc. and this may cause problems such as packet fragmentation, lower performance and/or termination of TCP sessions. This is especially a common problem in mobile backhaul networks where the end-user traffic is encapsulated in tunnels from the mobile system. The traffic can also be further encapsulated in IPSec, the mobile system traffic can then be encapsulated a second or third time by the mobile backhaul networks, e.g. in MPLS, and even a fourth time when back-up tunnels are used.

In order to get efficient throughput of data packets, the MTU size must be small enough to fit within the frame format of the underlying technology end-to-end. If the packet is bigger than the maximum frame size of the underlying network, it is necessary to break up the packet into several pieces, a process called fragmentation. The packets are then sent individually and reassembled into the original message. The fragmentation increases the packet processing, lowers the performance and may introduce packet re-ordering.

To find out what the MTU size is along the path, the networks use path MTU discovery. Path MTU Discovery works by setting a Don't Fragment, DF, option bit in the IP headers of outgoing data packets. Then, any device along the path whose MTU size is smaller than the frame size of the sent data packets will drop them, and return an Internet Control Message Protocol, ICMP, Fragmentation Needed (Type 3, Code 4) message containing its MTU size, allowing the source host to reduce its Path MTU parameter appropriately. The process is repeated until the MTU size is small enough to traverse the entire path without fragmentation.

### SUMMARY

However, the path MTU discovery has drawbacks. Once the MTU path discovery procedure is finished, it may take a while before the next iteration of the discovery is performed again. According to the path MTU discovery RFCs, the discovery process must not be done earlier than in 5 minutes, and the real configurations may have much higher values. Another drawback of the path MTU discovery mechanisms described in RFCs is that they are rather complex to implement and do not provide the simple way of detection of path MTU reduction when ICMP messages cannot be used, for example, the ICMP messages are suppressed by the network equipment.

Thus, some of the example embodiments presented herein may be directed towards improved MTU handling. Such improved MTU handling may be provided by the verification of SCTP associated paths with the use of an extended heartbeat message. At least one example advantage of some of the example embodiments may be improved throughput of SCTP. Another example advantage of some of the example embodiments may be a reduction or avoidance of traffic bouncing.

Accordingly, some of the example embodiments are directed towards an originating network node for managing a Maximum Transfer Unit (MTU) related path failure. The method comprises identifying a path with a retransmission count is equal to or greater than a predetermined heartbeat threshold value. The method also comprises extending a heartbeat message size according to an assumed maximum message transfer size. The method also comprises sending the extended heartbeat message over an identified path, and managing the identified path based on results of the extended heartbeat message transmission.

Some of the example embodiments are directed towards an originating network node for managing an MTU related path failure. The originating network node comprises processing circuitry configured to identify a path with a retransmission count is equal to or greater than a predetermined heartbeat threshold value. The processing circuitry is further configured to extend a heartbeat message size according to a maximum message transfer size. The originating node further comprises radio circuitry configured to send the extended heartbeat message over an identified path. The processing circuitry is further configured to manage the identified path based on results of the extended heartbeat message transmission.

Some of the example embodiments are directed towards a method, in an intermediate node, for detecting an MTU related path failure. The method comprises receiving, from the originating node, an extended heartbeat message, said extended heartbeat message comprising a size equal to a maximum message transfer size; and sending a transmission result based on the receiving.

Some of the example embodiments are directed towards an intermediate node for detecting an MTU related path failure. The intermediate node comprises radio circuitry configured to receive, from the originating node, an extended heartbeat message, said extended heartbeat message comprising a size equal to a maximum message transfer size. The radio circuitry is further configured to send a transmission result based on the receiving.

Some of the example embodiments are directed towards a computer-readable medium having computer-executable instructions for managing a MTU related path failure in an originating network node. The instructions comprise identifying a path with a re-transmission count that is equal to or greater than a predetermined heartbeat threshold value. The instructions also comprise extending a heartbeat message size according to a maximum message transfer size, and sending the extended heartbeat message over the identified path. The instructions further comprise managing the identified path based on results of the extended heartbeat message transmission.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1 and 2 are illustrative examples of communication systems comprising MTU related path failures;

FIGS. 3 and 4 are illustrative examples of communication systems comprising MTU related path failures, according to some of the example embodiments presented herein;

FIG. 5 is an example node configuration of an originating node, according to some of the example embodiments;

FIG. 6 is an example node configuration of an intermediate node, according to some of the example embodiments;

FIG. 7 is a flow diagram depicting example operations of the originating node of FIG. 5, according to some of the example embodiments; and

FIG. 8 is a flow diagram depicting example operations of the intermediate node of FIG. 6, according to some of the example embodiments.

### DETAILED DESCRIPTION

In the following description, for purposes of explanation and not limitation, specific details are set forth, such as particular components, elements, techniques, etc. in order to provide a thorough understanding of the example embodiments. However, it will be apparent to one skilled in the art that the example embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

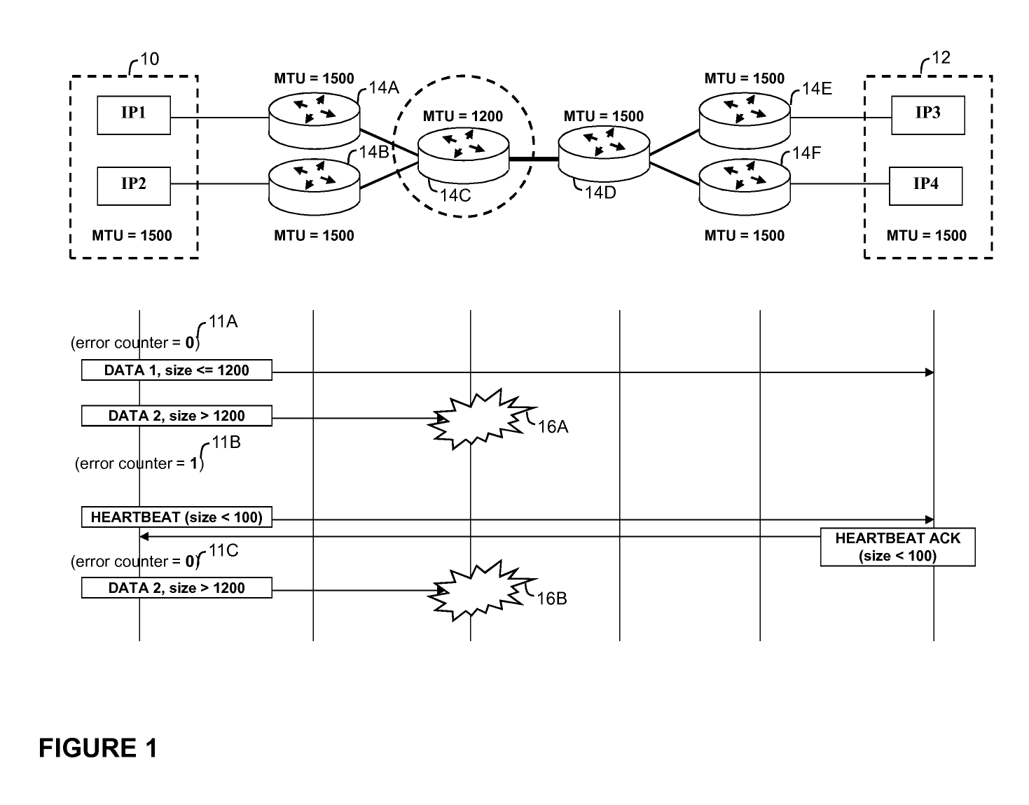

In order to provide a better explanation of the example embodiments presented herein, a problem will first be identified and discussed. FIG. 1 illustrates an example of a communications system featuring two communication end points 10 and 12. Below the illustrated system, FIG. 1 further illustrates example messages which may be sent by the various nodes. Endpoint 10 may be characterized as an originating node as this is the point in the network where a data message to be transmitted originates from. Endpoint 12 may be characterized as a destination node as this is the point in the network where the data message to be transmitted is sent to.

Along the path from the originating node 10 to the destination node 12, there may be any number of intermediate nodes (e.g., switches or routers) with different MTUs, for example intermediate nodes 14A-14F, as illustrated in FIG. 1. The intermediate nodes may be characterized as nodes which will receive the transmitted data message and, if possible, forward the message along to the destination node 12. The originating, destination and intermediate nodes all comprise an associated MTU size. As illustrated, the originating node 10, destination node 12 and intermediate nodes 14A, 14B and 14D-14F all comprise an associated MTU size of 1500. In the example provided by FIG. 1, the intermediate node labelled 14C comprises an associated MTU size of 1200.

In operation, an error counter (or re-transmission counter) 11A may initially be set to zero. An error or re-transmission counter with a value of zero may represent that there has not been an attempt to retransmit a data message due to any sort of failure. In some example embodiments, it is the originating node which maintains the error or re-transmission counter. According to some of the example embodiments, the error or re-transmission counter may be maintained for any number of paths between an originating 10 and destination 12 node.

The originating node 10 may send a data message, DATA 1, to the destination node 12. As shown in the example provided by FIG. 1, DATA 1 comprises a message size which is less than or equal to 1200. Since all of the intermediate nodes 14A-14F comprise an associated MTU size which is at least 1200, DATA 1 may successfully reach the destination node 12, assuming there are no other transmission errors.

However, if a data message which is larger than 1200 is sent, any intermediate node which does not have an appropriate MTU size may not be able to handle the message. As shown in FIG. 1, DATA 2, comprising a message size which is greater than 1200, is sent. Once DATA 2 reaches intermediate node 14C, which has an associated MTU size of 1200, the message may be dropped 16A. The originating node 10 may detect that the DATA 2 message is lost, thus the error or re-transmission counter may be incremented to 1, as shown in FIG. 1, 11B. Once the originating node 10 detects that there has been a failure on a path, or when the error or re-transmission counter exceeds a threshold value (e.g., Path.Max.Retrans), the failed path may be monitored using Heartbeat messages. Heartbeat messages are typically smaller in size.

In the example provided in FIG. 1, a Heartbeat message comprising a size of less than 100 is sent to the destination node 12. As all of the associated intermediate nodes 14A-14F comprise associated MTU sizes which are above 100, the Heartbeat message may be successfully received by the destination node 12, assuming there are no other transmission errors. The destination node 12 may send a Heartbeat acknowledgement message back to the originating node 10. Once the originating node 10 receives the Heartbeat acknowledgement message, the originating node 10 may reset the error or re-transmission counter back to zero, as is illustrated in FIG. 1, 11C.

Once the error or re-transmission counter has been reset to zero, the originating node 10 may attempt to send data on the same path (e.g., featuring the intermediate node 14C). Thus, the failed data message, DATA 2, may be resent and since the intermediate node 14C still comprise an MTU size of 1200, the data transmission may again fail 16B. The path will be continued to be monitored with Heartbeat messages, resulting in an infinite loop of resetting the error or retransmission counter and the resending of Heartbeat messages. Such an infinite loop may only stop when path MTU discovery is finished.

Thus, data packets with a size greater than the size of the smallest associated MTU size are discarded, causing an increase of the re-transmission counter. Normally, as soon as the re-transmission counter exceeds a value (e.g., Path.Max.Retrans), the path is excluded from traffic until successful delivery of a Heartbeat message over it. The Heartbeats were successfully passing over such path, resetting retransmission counter, keeping association alive and making that path available for traffic again (even though it is not able to transfer some data packets). The consequence of such behaviour is that data packets are not delivered to the destination node, resulting in never-ceasing congestion on the transmitting side, but the SCTP association is kept alive even though no data may be delivered to the destination node.

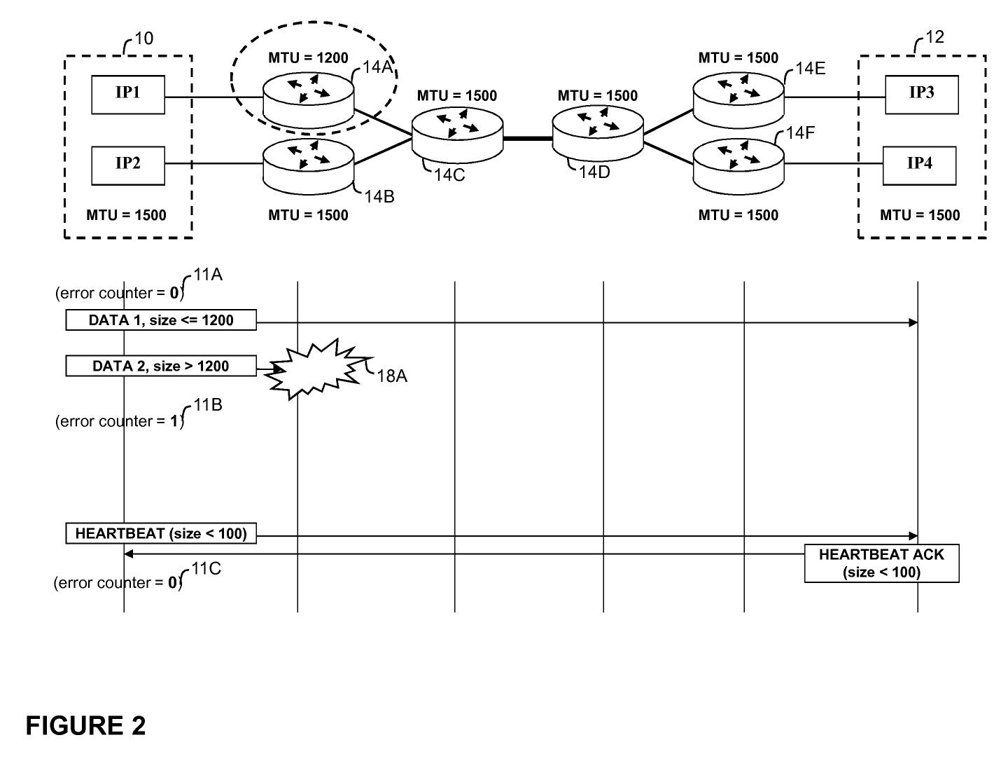

FIG. 2 illustrates the communications system of FIG. 1, wherein now intermediate node 14A comprises an associated MTU size of 1200 and intermediate node 14C comprises an associated MTU size of 1500. In operation, the error or re-transmission counter 11A may initially be set to zero. The originating node 10 may send a data message, DATA 1 comprising a size which is less than or equal to 1200, to the destination node 12. Since all of the intermediate nodes 14A-14F comprise an associated MTU size that is at least 1200, the data message may be received by the destination node 12, assuming there are no other transmission errors.

Once a message is sent which comprises a size above 1200, for example message DATA 2, an error may occur. Since intermediate node 14A comprises an associated MTU size of 1200, DATA 2 may be dropped 18A. Once the originating node 10 detects the error, the error or re-transmission counter may be incremented 11B. Thereafter, the failed path may be monitored using Heartbeat messages. Heartbeat messages are typically smaller in size. In contrast to the scenario of FIG. 1, in FIG. 2, an alternate data path for DATA 2 exists (e.g., via intermediate nodes 14B, 14C, 14D and 14E or 14F). Thus, while the failed path is being monitored via the Heartbeat message, DATA 2 may be transmitted on the alternate path.

As shown in FIG. 2, the Heartbeat message, comprising a size of less than 100 may be transmitted and received by the destination node 12, assuming there are no transmission errors. The destination node 12 may in-turn send a Heartbeat acknowledge message to the originating node 10. Once the originating node 10 receives the acknowledgement message, the originating node 10 may reset the error or re-transmission counter to zero, as shown in FIG. 2, 11C. Similarly to FIG. 1, such a scenario may also cause an infinite loop. In the loop of FIG. 2, data transmissions may be caused to switch or bounce back and forth between different data paths, thereby resulting in extra re-transmissions (e.g., for dropped data) and lowered throughput.

Thus, once the SCTP, or the originating node, detects re-transmissions over a failed path, it can switch over to the alternative data transfer path. The SCTP will continue to monitor the original primary path by the Heartbeat messages, which may be successfully delivered, so the SCTP may switch the data transfer back to the original primary path. Once some data is not delivered again, SCTP may switch to the alternative path again. The situation repeats again and again, resulting in the bouncing of traffic between the paths, decreasing the overall throughput of the association. The bouncing will stop only when the path MTU discovery is finished.

Thus, in order to remedy at least the above mentioned problem, some of the example embodiments presented herein may be directed towards an improved method of the verification of SCTP association paths. Some of the example embodiments may comprise monitoring paths with the use of extended Heartbeat messages. The Heartbeat messages may be extended such that if the Heartbeat message is successfully received, there is a high probability the data messages will also be received.

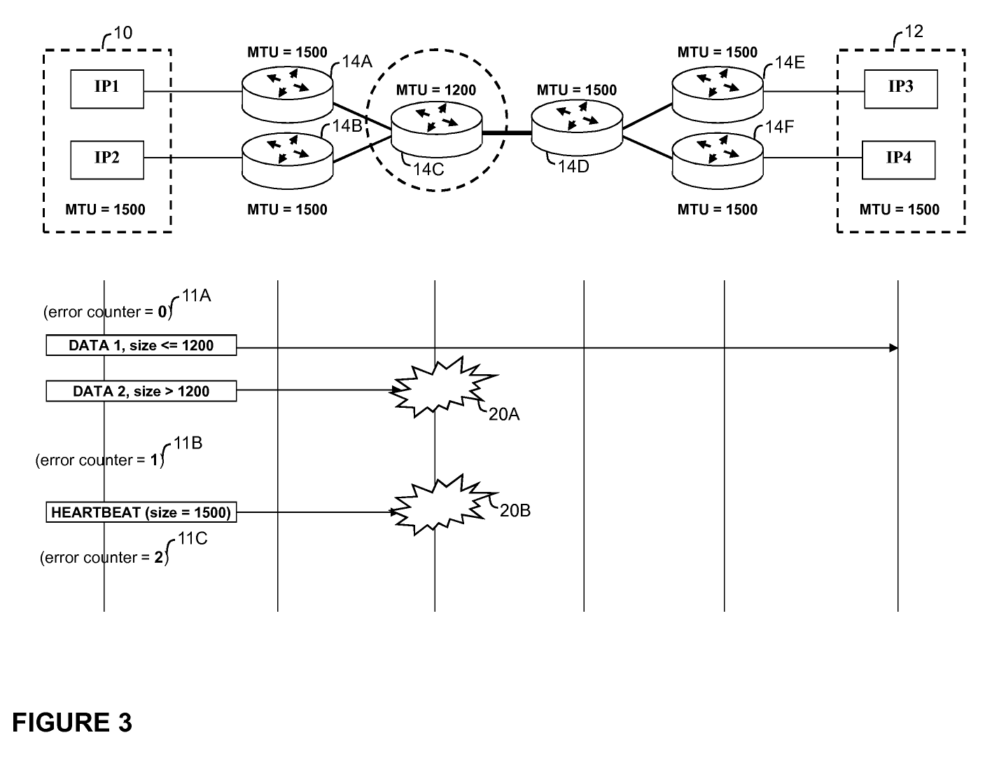

FIG. 3 illustrates a communications system, similar to the system illustrated in FIG. 1, which incorporates some of the example embodiments. In operation, the error or re-transmission counter may initially be set to zero 11A. The originating node 10 may send a data message, DATA 1 with a message size that is less than or equal to 1200, to a destination node 12. Since all of the intermediate nodes 14A-14F comprise an associated MTU size which is at least equal to 1200, the message may be received by the destination node 12, assuming there are no other transmission errors. However, once the originating node 10 attempts to send a data message, DATA 2, which has a size greater than 1200, the message will be dropped 20A since intermediate node 14C comprises an associated MTU size of 1200.

Upon receiving notice, or determining, that the transmission of DATA 2 failed, the originating node 10 may increment the error or re-transmission counter, as shown in FIG. 3, 11B. According to some of the example embodiments, the originating node 10 may be configured to determine that the transmission of data has failed on a particular path by discovering that an acknowledgement message has not been sent by destination 12 after a predetermined period of time. According to some of the example embodiments, the originating node 10 may receive a failure notification (or a notification of an interruption in a data transfer) from any of the intermediate nodes 14A-14F. It should be appreciated that the originating node 10 may determine or be notified of the transmission failure by any other node or means known in the art.

According to some of the example embodiments, once the error or re-transmission counter has been incremented, the originating node 10 may evaluate the value of the error or re-transmission counter. If the value of the error or re-transmission counter is equal to or above a predetermined threshold value (e.g., a predetermined heartbeat threshold value), the originating node may begin to monitor the failed path using extended Heartbeat messages. According to some of the example embodiments, the predetermined threshold value may be 1. In such an instance, once a data transmission failure has occurred, the failed path may begin to be monitored. It should be appreciated that the predetermined threshold value may take on any value. It should be further appreciated that such a value may be dynamic or changeable based on any number of factors (e.g., type of service or application associated with the data).

Once the originating node 10 has determined that the failed path is to be monitored, the originating node 10 may send an extended Heartbeat message. According to some of the example embodiments, the Heartbeat message may be extended according to an assumed maximum message transfer size. According to some of the example embodiments, the maximum message transfer size may be determined by the SCTP. In the example provided by FIG. 3, the maximum message transfer size is 1500. Thus, the Heartbeat message may be extended with PAD chunk(s) in such a way that the resulting message will have the maximum transfer size. It should be appreciated that the size of 1500 may comprise the size of the DATA with the addition of the PAD and any associated headers.

Upon the transmission of the extended Heartbeat message, a failure 20B will occur as the message reaches intermediate node 14C since the associated MTU size of the intermediate node (1200) is lower than the size of the extended Heartbeat message (1500). Thereafter, the error or re-transmission counter may be further incremented, as shown in FIG. 3, 11C. Thus, there is no reset of the error or re-transmission counter to zero, as was the case in FIG. 1. According to some example embodiments, once the error or re-transmission counter has passed another threshold value (e.g., an inactivation threshold value), the association (e.g., SCTP association) may be dropped and later re-established with a different associated MTU size.

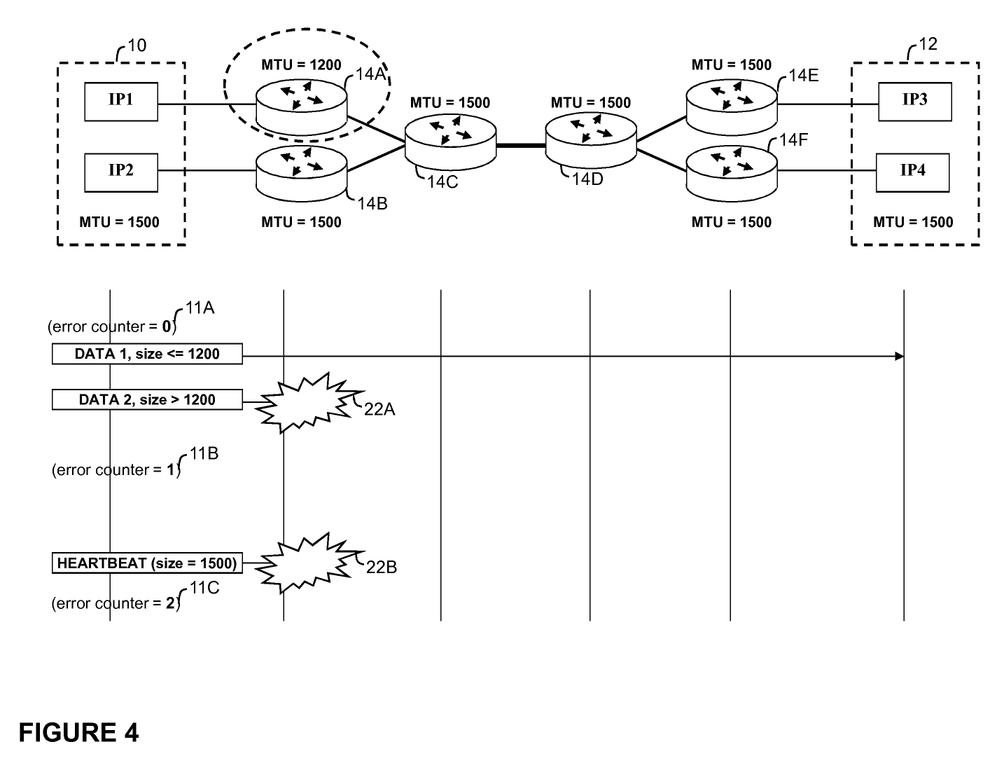

FIG. 4 illustrates a communications system similar to that of FIG. 2, incorporating some of the example embodiments presented herein. In operation, the error or re-transmission counter may initially be set to zero 11A. The originating node 10 may send a data message, DATA 1 with a message size that is less than or equal to 1200, to a destination node 12. Since all of the intermediate nodes 14A-14F comprise an associated MTU size which is at least equal to 1200, the message may be received by the destination node 12, assuming there are no other transmission errors. However, once the originating node 10 attempts to send a data message, DATA 2, which has a size greater than 1200, the message will be dropped 22A since intermediate node 14A comprises an associated MTU size of 1200.

Upon receiving notice, or determining, that the transmission of DATA 2 failed, the originating node 10 may increment the error or re-transmission counter, as shown in FIG. 4, 11B. According to some of the example embodiments, the originating node 10 may be configured to determine that the transmission of data has failed on a particular path in a similar manner as described above in relation to FIG. 3.

According to some of the example embodiments, once the error or re-transmission counter has been incremented, the originating node 10 may evaluate the value of the error or re-transmission counter and decide to send an extended Heartbeat message in a similar manner as described in FIG. 3.

Upon the transmission of the extended Heartbeat message, a failure 22B will occur as the message reaches intermediate node 14A since the associated MTU size of the intermediate node (1200) is lower than the size of the extended Heartbeat message (1500). Thereafter, the error or re-transmission counter may be further incremented, as shown in FIG. 4, 11C. Thus, there is no reset of the error or re-transmission counter to zero or there is transmission of data on an alternative path (e.g., there will be no switching with respect to the original data path), as was the case in FIG. 2. According to some example embodiments, the failed path may be inactivated and may not be used for data transmission unless an extended Heartbeat message is successfully transmitted or if the failed path is re-established with a different associated MTU size.

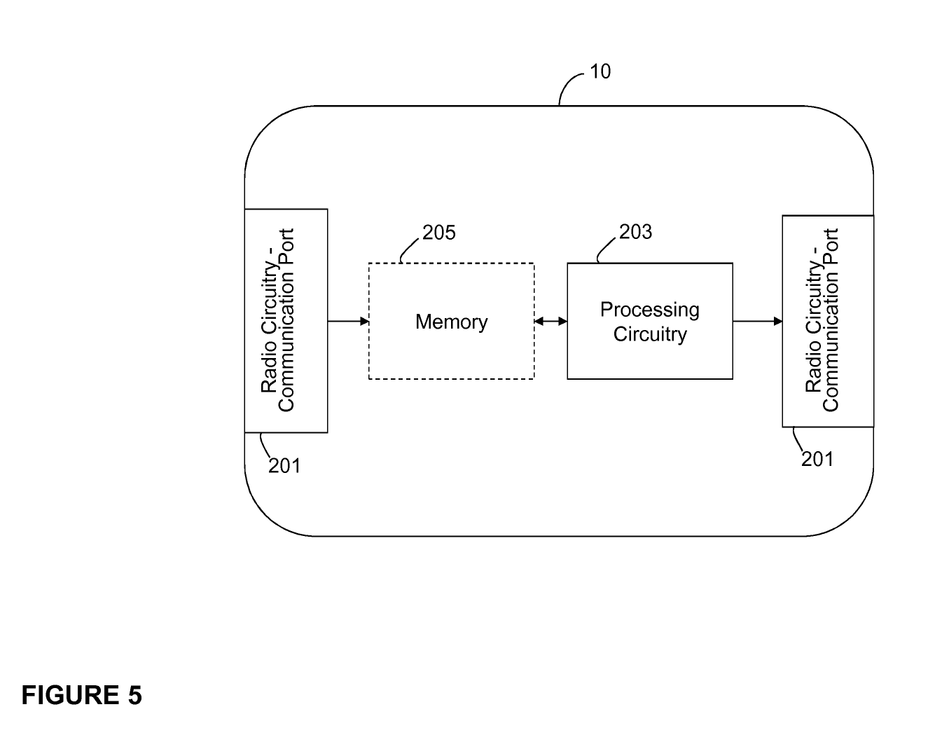

FIG. 5 illustrates an example node configuration of an originating node 10, which may be configured to utilize some of the example embodiments disclosed herein. The originating node 10 may comprise radio circuitry or a communication port 201 that may be configured to receive and/or transmit communication data, instructions, and/or messages. It should be appreciated that the radio circuitry or communication port 201 may be comprised as any number of transceiving, receiving, and/or transmitting units or circuitry. It should further be appreciated that the radio circuitry or communication 201 may be in the form of any input/output communications port known in the art. The radio circuitry or communication 201 may comprise RF circuitry and baseband processing circuitry (not shown).

The originating node 10 may also comprise a processing unit or circuitry 203 which may be configured to manage MTU related path failures. The processing circuitry 203 may be any suitable type of computation unit, e.g. a microprocessor, digital signal processor (DSP), field programmable gate array (FPGA), or application specific integrated circuit (ASIC), or any other form of circuitry. The originating node 10 may further comprise a memory unit or circuitry 205 which may be any suitable type of computer readable memory and may be of volatile and/or non-volatile type. The memory 205 may be configured to store received, transmitted, and/or measured data, device parameters, communication priorities, and/or executable program instructions.

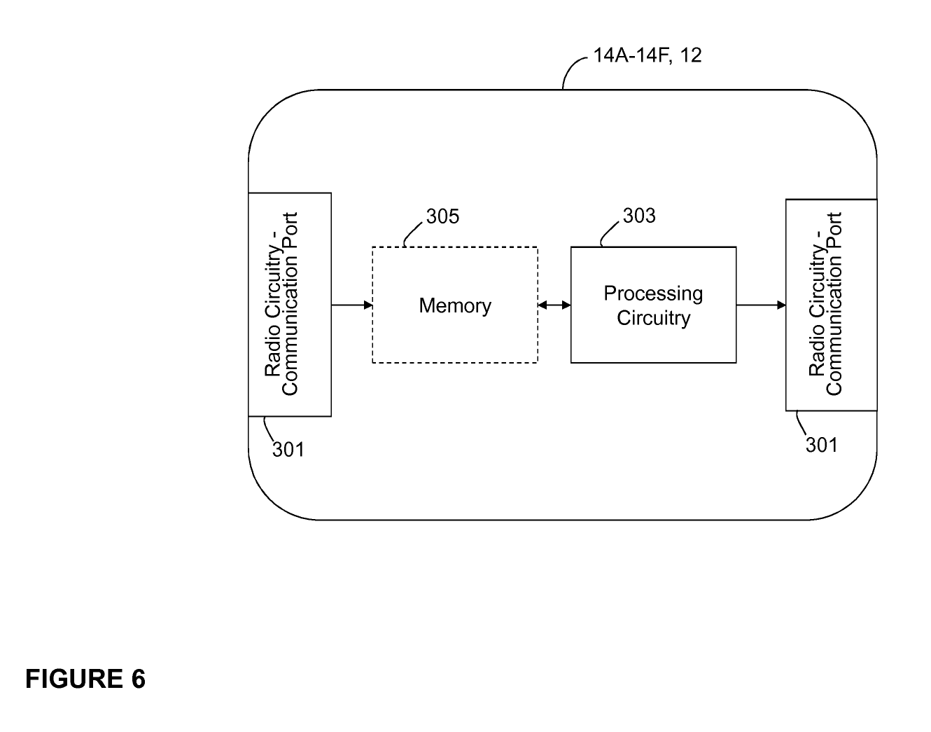

FIG. 6 illustrates an example node configuration of an intermediate node or a destination node, which may be any of intermediate nodes 14A-14F or destination node 12 of FIGS. 1-4, which may be configured to utilize some of the example embodiments disclosed herein. The intermediate node 14A-14F or the destination node 12 may comprise radio circuitry or a communication port 301 that may be configured to receive and/or transmit communication data, instructions, and/or messages. It should be appreciated that the radio circuitry or communication port 301 may be comprised as any number of transceiving, receiving, and/or transmitting units or circuitry. It should further be appreciated that the radio circuitry or communication 301 may be in the form of any input/output communications port known in the art. The radio circuitry or communication 301 may comprise RF circuitry and baseband processing circuitry (not shown).

The intermediate node 14A-14F or the destination node 12 may also comprise a processing unit or circuitry 303 which may be configured to manage MTU related path failures. The processing circuitry 303 may be any suitable type of computation unit, e.g. a microprocessor, digital signal processor (DSP), field programmable gate array (FPGA), or application specific integrated circuit (ASIC), or any other form of circuitry. The intermediate node 14A-14F may further comprise a memory unit or circuitry 305 which may be any suitable type of computer readable memory and may be of volatile and/or non-volatile type. The memory 305 may be configured to store received, transmitted, and/or measured data, device parameters, communication priorities, and/or executable program instructions.

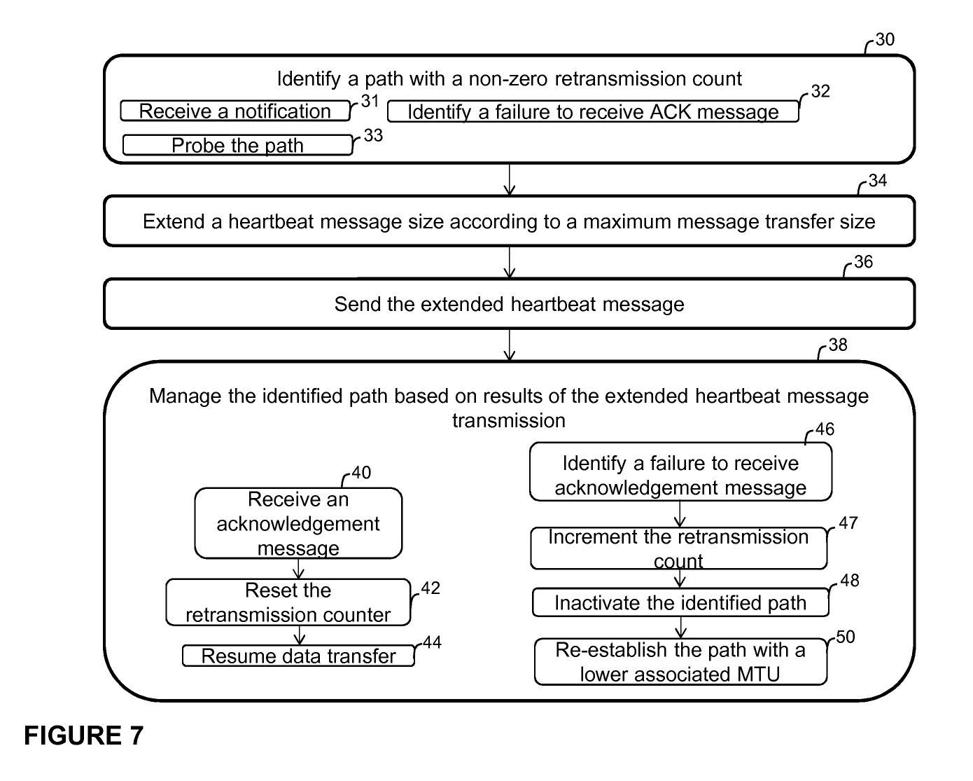

FIG. 7 is a flow diagram depicting example operations which may be taken by the originating node 10 of FIG. 5 in the management of an MTU related path failure. It should also be appreciated that FIG. 7 comprises some operations which are illustrated with a darker border and some operations which are illustrated with a lighter border. The operations which are comprised in a darker border are operations which are comprised in the broadest example embodiment. The operations which are comprised in a lighter border are example embodiments which may be comprised in, or a part of, or are further operations which may be taken in addition to the operations of the boarder example embodiments. It should be appreciated that these operations need not be performed in order. Furthermore, it should be appreciated that not all of the operations need to be performed. The example operations may be performed in any order and in any combination.

### Example Operation 30

According to some of the example embodiments, the originating node 10 is configured to identify 30 a path with a non-zero re-transmission count that is equal to or greater than a predetermined heartbeat threshold value. The processing circuitry 203 is configured to identify the path with the non-zero re-transmission count that is equal to or greater than a predetermined heartbeat threshold value.

According to some of the example embodiments, the predetermined heartbeat threshold value may be a Path.Max.Retrans value. According to some of the example embodiments, the predetermined heartbeat threshold value may be 1. According to some of the example embodiments, the predetermined heartbeat threshold value may be dynamic and/or may depend on a service or application. It should be appreciated that the predetermined heartbeat threshold value may take on any value. According to some of the example embodiments, the originating node 10 may be configured to use SCTP.

### Example Operation 31

According to some of the example embodiments, the identifying 30 may further comprise receiving 31, from an intermediate node 14A-14F, a notification of an interruption in a data transfer of the identified path. The radio circuitry 201 may be configured to receive, from an intermediate node 14A-14F, a notification of an interruption in a data transfer of the identified path.

### Example Operation 32

According to some of the example embodiments, the identifying 30 may comprise identifying 32 a failure to receive an acknowledgement message from a destination node 12, with respect to a prior transmission of data, after a predetermined period of time. The processing circuitry 203 may be configured to identify the failure to receive the acknowledgment message, from the destination node, after the predetermined period of time. It should be appreciated that the predetermined period of time may be provided according to a SCTP retransmission timeout value which may be calculated dynamically based on a measured round-trip time for data transmission.

### Example Operation 33

According to some of the example embodiments, the identifying 30 may comprise providing 33 the path in order to analyze the re-transmission count associated with the path. The processing circuitry 203 may be configured to probe the path in order to analyze the re-transmission count associated with the path. Thus, the different paths utilized by the originating node 10 may be probed or checked to monitor the re-transmission counter or possible failures of such paths. It should be appreciated that such probing may be provided by based on rules or a configuration internal to the originating node 10. It should further be appreciated that the intermediate nodes 14A-14F may also be probed in as similar manner.

### Example Operation 34

According to some of the example embodiments, the originating node 10 is also configured to extend 34 a heartbeat message size according to a maximum message transfer size. The processing circuitry 203 is configured to extend the heartbeat message size according to the maximum message transfer size. According to some of the example embodiments, the maximum message transfer size may be determined by a SCTP.

### Example Operation 36

According to some of the example embodiments, the originating node 10 may also be configured to send 36 the extended heartbeat message over the identified path. The radio circuitry 201 is configured to send the extended heartbeat message over the identified path.

### Example Operation 38

According to some of the example embodiments, the originating node 10 is further configured to manage 38 the identified path based on results of the extended heartbeat message transmission. The processing circuitry 203 is configured to manage the identified path based on the results of the extended heartbeat message transmission.

### Example Operation 40

According to some of the example embodiments, the managing 38 may further comprise receiving 40, from a destination node 12, an acknowledgement message. The acknowledgement message may acknowledge a receipt of the extended heartbeat message. The radio circuitry 201 may be configured to receive, from the destination node 12, the acknowledgement message.

### Example Operation 42

According to some of the example embodiments, the managing 38 and the receiving 40 may further comprise resetting 42 the re-transmission count to zero. The processing circuitry 203 may reset the re-transmission count to zero.

### Example Operation 44

According to some of the example embodiments, the managing 38, receiving 40 and resetting 42 may further comprise resuming 44 data transmission over the identified path if the identified path has been inactivated. The processing circuitry 203 may be configured to resume a data transmission over the identified path if the identified path has been inactivated.

### Example Operation 46

According to some of the example embodiments, the managing 38 may further comprise identifying 46 a failure to receive an acknowledgement message from a destination node 12, with respect to a receipt of the extended heartbeat message, after a predetermined period of time. The processing circuitry 203 may be configured to identify the failure to receive the acknowledgment message from the destination node 12, with respect to a receipt of the extended heartbeat message, after a predetermined period of time.

### Example Operation 47

According to some of the example embodiments, the managing 38 and identifying 46 may further comprise incrementing 47 the re-transmission count associated with the identified path. The processing circuitry 203 may be configured to increment the re-transmission count associated with the identified path.

### Example Operation 48

According to some of the example embodiments, the managing 38, the identifying 46 and the incrementing 47 may further comprise inactivating 48 the identified path for future data transmissions if the re-transmission count associated with the identified path is greater than or equal to a predetermined inactive threshold value. The processing circuitry 203 may be configured to inactivate the identified path for future data transmissions if the re-transmission count associated with the identified path is greater or equal to a predetermined inactive threshold value.

### Example Operation 50

According to some of the example embodiments, the managing 38, the identifying 46, the incrementing 47 and the inactivating 48 may further comprise re-establishing 50 the identified path for data transmissions. According to some of the example embodiments, the identified path may be re-established with a lower associated MTU. The processing circuitry 203 may be configured to re-establish the identified path for data transmissions.

It should be appreciated that according to some of the example embodiments the identified path may be a volatile path. Thus, the identified path may change throughout the course of any of the example operations discussed herein.

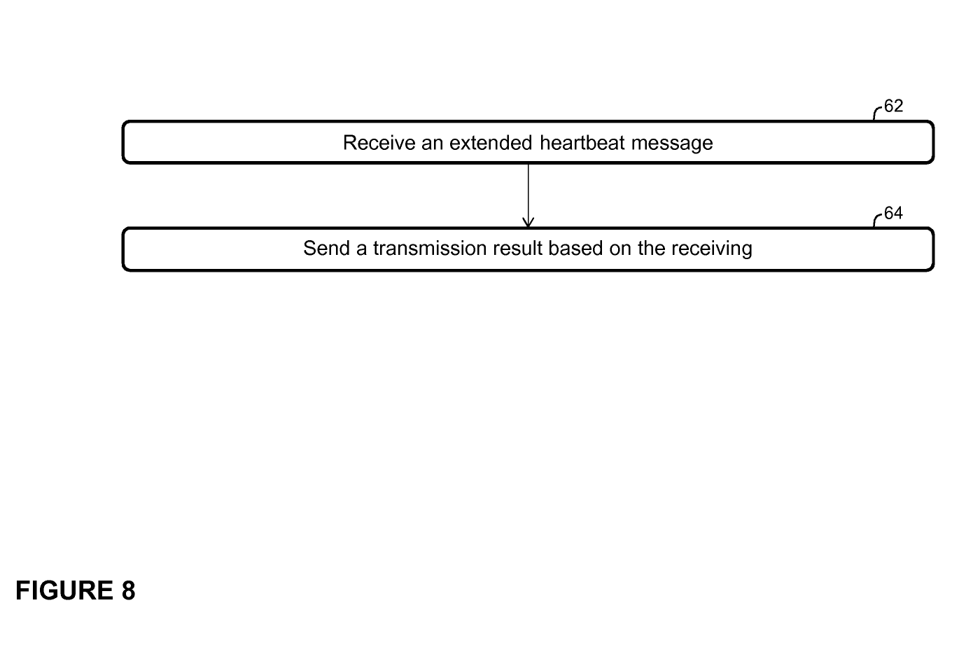

FIG. 8 is a flow diagram depicting example operations which may be taken by the intermediate node 14A-14F or the destination node 12 of FIG. 6 in the management of an MTU related path failure. It should be appreciated that the operations of FIG. 8 need not be performed in order. Furthermore, it should be appreciated that not all of the operations need to be performed. The example operations may be performed in any order and in any combination.

### Example Operation 62

According to some of the example embodiments, the intermediate node 14A-14F or the destination node 12 is configured to receive 62, from the originating node 10, an extended heartbeat message. The extended heartbeat message may be extended according to a size equal to a maximum message transfer size. The radio circuitry 301 may be configured to receive, from the originating node 10, the extended heartbeat message. According to some of the example embodiments, the maximum message transfer size may be provided via SCTP.

### Example Operation 64

According to some of the example embodiments, the intermediate node 14A-14F or the destination node 12 is further configured to send 64 a transmission result based on the receiving. The radio circuitry 301 may be configured to send the transmission result based on the receiving.

According to some of the example embodiments, the transmission result is an acknowledgement message with respect to a receipt of the extended heartbeat message. Such an acknowledgement message may be sent by the destination node. According to some of the example embodiments, the extended heartbeat message may not be properly received, thus, the transmission result may be a notification of an interruption in a data transmission. Such a notification may be sent by the intermediate node or the destination node. According to some of the example embodiments, the transmission result may be sent to the originating node 10.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that the example embodiments presented herein may be practiced in any combination with each other.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the claims, that the example embodiments may be implemented at least in part by means of both hardware and software, and that several “means”, “units” or “devices” may be represented by the same item of hardware.

Also note that terminology such as user equipment should be considered as non-limiting. A device or user equipment as the term is used herein, is to be broadly interpreted to include a radiotelephone having ability for Internet/intranet access, web browser, organizer, calendar, a camera (e.g., video and/or still image camera), a sound recorder (e.g., a microphone), and/or global positioning system (GPS) receiver; a personal communications system (PCS) user equipment that may combine a cellular radiotelephone with data processing; a personal digital assistant (PDA) that can include a radiotelephone or wireless communication system; a laptop; a camera (e.g., video and/or still image camera) having communication ability; and any other computation or communication device capable of transceiving, such as a personal computer, a home entertainment system, a television, etc. It should be appreciated that the term user equipment may also comprise any number of connected devices.

The various example embodiments described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

1. A method, in an originating network node, for managing a Maximum Transfer Unit, MTU, related path failure, the method comprising:
identifying a path with a re-transmission count that is equal to or greater than a predetermined heartbeat threshold value;
extending a heartbeat message size according to a maximum message transfer size;
sending the extended heartbeat message over the identified path; and
managing the identified path based on results of the extended heartbeat message transmission.

2. The method of claim 1, wherein the predetermined heartbeat threshold value is one.

3. The method of claim 1, wherein the identifying further comprises receiving, from an intermediate node, a notification of an interruption in a data transfer over the identified path.

4. The method of claim 1, wherein the identifying further comprises identifying a failure to receive an acknowledgement message from a destination node, with respect to a prior transmission of data, after a predetermined period of time.

5. The method of claim 1, wherein the identifying further comprises probing the path in order to analyze the re-transmission count associated with the path.

6. The method of claim 1, wherein the managing further comprises:
receiving, from a destination node, an acknowledgement message, said acknowledgment message acknowledging a receipt of the extended heartbeat message;
resetting the re-transmission count to zero; and
if said identified path has been inactivated, resuming data transmission over the identified path.

7. The method of claim 1, wherein the managing further comprises:
identifying a failure to receive an acknowledgement message from a destination node, with respect to a receipt of the extended heartbeat message, after a predetermined period of time;
incrementing the re-transmission count associated with identified path; and
if the re-transmission count associated with the identified path is greater or equal to a predetermined inactive threshold value, inactivating the identified path for future data transmissions.

8. The method of claim 7, further comprising re-establishing the identified path for data transmissions, wherein said identified path is re-established with a lower associated MTU.

10. The method of claim 1, wherein the identified path is a volatile path.

11. The method of claim 1, wherein the originating node utilizes Stream Control Transmission Protocol (SCTP).

12. An originating network node for managing a Maximum Transfer Unit, MTU, related path failure, the originating network node comprising:
processing circuitry configured to identify a path with a re-transmission count that is equal to or greater than a predetermined heartbeat threshold value;
the processing circuitry further configured to extend a heartbeat message size according to a maximum message transfer size;
radio circuitry configured to send the extended heartbeat message over the identified path; and
the processing circuitry further configured to manage the identified path based on results of the extended heartbeat message transmission.

13. The originating network node of claim 12, wherein the predetermined heartbeat threshold value is one.

14. The originating network node of claim 12, wherein the radio circuitry is further configured to receive, from an intermediate node, a notification of an interruption in a data transfer over the identified path, said notification being used by the processing circuitry in order to identify the path with the re-transmission count equal to or greater than the predetermined heartbeat threshold value.

15. The originating network node of claim 12, wherein the processing circuitry is further configured to identify a failure to receive an acknowledgement message from a destination node, with respect to a prior transmission of data, after a predetermined period of time.

16. The originating network node of claim 12, wherein the processing circuitry is further configured to probe the path in order to analyze the re-transmission count associated with the path.

17. The originating network node of claim 12, wherein the radio circuitry is further configured to receive, from a destination node, an acknowledgement message, said acknowledgment message acknowledging a receipt of the extended heartbeat message; and the processing circuitry is further configured to reset the re-transmission count to zero, wherein if said identified path has been inactivated, the processing circuitry is also configured to resume data transmission over the identified path.

18. The originating network node of claim 12, wherein the processing circuitry is further configured to identify a failure to receive an acknowledgement message from a destination node, with respect to a receipt of the extended heartbeat message, after a predetermined period of time; the processing circuitry is also configured to increment the re-transmission count associated with identified path; wherein if the retransmission count associated with the identified path is greater or equal to a predetermined inactive threshold value, the processing node is further configured to inactivate the identified path for future data transmissions.

19. The originating network node of claim 18, wherein the processing circuitry is further configured to re-establish the identified path for data transmissions, wherein said identified path is re-established with a lower associated MTU.

20. The originating network node of claim 12, wherein the identified path is a volatile path.

21. The originating network node of claim 12, wherein the originating node utilizes Stream Control Transmission Protocol (SCTP).

22. A method, in node, for detecting a Maximum Transfer Unit, MTU, related path failure, the method comprising:
receiving, from the originating node, an extended heartbeat message, said extended heartbeat message comprising a size equal to a maximum message transfer size; and
sending a transmission result based on the receiving.

23. The method of claim 22, wherein the node is a destination node and the transmission result is an acknowledgement message with respect to a receipt of the extended heartbeat message.

24. The method of claim 22, wherein the node is an intermediate or a destination node and the extended heartbeat message was improperly received, wherein the transmission result is a notification of an interruption in a data transmission.

25. A node for detecting a Maximum Transfer Unit, MTU, related path failure, the intermediate node comprising:
radio circuitry configured to receive, from the originating node, an extended heartbeat message, said extended heartbeat message comprising a size equal to a maximum message transfer size; and
the radio circuitry further configured to send a transmission result based on the receiving.

26. The node of claim 25, wherein the node is a destination node and the transmission result is an acknowledgement message with respect to a receipt of the extended heartbeat message.

27. The node of claim 25, wherein the node is an intermediate node or a destination node and the extended heartbeat message was improperly received, wherein the transmission result is a notification of an interruption in a data transmission.

28. A computer-readable medium having computer-executable instructions for managing a Maximum Transfer Unit, MTU, related path failure in an originating network node, the instructions comprising:
identifying a path with a re-transmission count that is equal to or greater than a predetermined heartbeat threshold value;
extending a heartbeat message size according to a maximum message transfer size;
sending the extended heartbeat message over the identified path; and
managing the identified path based on results of the extended heartbeat message transmission.
